(19) United States
(12) Patent Application Publication
(10) Pub. No.: US 2004/0012361 A1
(43) Pub. Date: Jan. 22, 2004

(54) Operating unit

(76) Inventors: Ulrich Gaertner, Nordstemmen (DE); Christopher Pflug, Hildesheim (DE); Stefan Karp, Frankfurt (DE)

Correspondence Address: KENYON & KENYON, ONE BROADWAY, NEW YORK, NY, 10004, US

(21) Appl. No.: 10/258,696

(22) PCT Filed: Apr. 27, 2001
(86) PCT No.: PCT/DE01/01588

(30) Foreign Application Priority Data
Apr. 28, 2000 (DE) 100 21 065.1

(51) Int. Cl. G05B 19/10

(52) U.S. Cl. 318/567

(57) ABSTRACT

Proposed is an operating unit for operating a user interface of an electrical device, the operating unit having a rotating body (1) that may rotate about an axis (9). According to the present invention, the rotating body may be tilted about an axis perpendicular to the axis of rotation.

### FIELD OF THE INVENTION

The present invention relates to an operating unit for operating a user interface of an electrical device, the operating unit having a rotating body that may rotate about an axis.

### BACKGROUND INFORMATION

In the case of input fields in vehicles, e.g. for operating a video screen of a driver information system, operating units are necessary whose degree of freedom is just sufficient for providing the required operator functionality, e.g. moving a cursor on the display from top to bottom and/or from left to right, are particularly necessary. This should ensure that the attention of a driver paid to the road traffic is not affected in an undesirable manner.

In some known driver information systems, input elements, e.g. in the form of a so-called rotary pressure sensor or a four-function toggle switch, are used for operating the user interface. The input elements are used for controlling menus, or also for inputting text in conjunction with a software mask for inputting alphanumeric characters, i.e. a so-called speller.

The intention is to be able to operate such input elements, using only one hand and as little eye contact as possible with the input element and the user interface operated by it.

In this regard, the input elements described above have the disadvantage that it is difficult for an operator, e.g. when moving a cursor on a video screen, to be able to easily understand the movement of the cursor without eye contact.

In order to achieve an improvement in this regard, the German Patent Application No. DE 199 26 596, which is not yet published, proposes equipping an operating element with a first setting element that may rotate about a first axis, and with a second setting element that may rotate about a second axis not coinciding with the first axis. The operating element should preferably have an essentially spherical design, the first adjusting element being spherical and the second adjusting element being essentially hemispherical and designed to at least partially surround the first adjusting element.

This allows good haptic feedback while moving, e.g. a cursor in two coordinate directions on a video screen, without requiring eye contact with the operating element, and requiring only limited eye contact or likewise no eye contact with a moving cursor on a video screen.

The two spherical adjusting elements placed inside each other allow approximately the same functionality to be attained as a “mouse”. However, such a degree of freedom is not required for many applications.

### SUMMARY OF THE INVENTION

An object of the present invention is to provide an operating unit for, in particular, a user interface displayed on a video screen, which ensures sufficient functionality, in particular for moving a cursor, in the case of a comparatively small degree of freedom.

This object is achieved by an operating unit of the type mentioned at the outset, in that the rotating body may be tilted about an axis transverse to, and preferably perpendicular to, its axis of rotation. This procedure allows, for example, a cursor in a menu to be moved down from the top or moved up from the bottom, by rotating the rotating body, the cursor being moved, e.g. to the right by tilting the rotating body. Using a rotating body that may be rotated slowly or rapidly, the operator may develop an idea of the corresponding cursor movement on a video screen relatively easily, by just rotating the wheel. The tilting of the rotating body allows, for example, a cursor in a menu to be moved from one column to the next adjacent column, which is something that is also easy for the operator to imagine without eye contact. Quick movements may still be carried out on a user interface. However, the operating unit does not have any unnecessary degrees of freedom, which, during the use of such an operating unit in a vehicle, would distract the driver from the traffic, since he or she would have to concentrate too much on manipulating the operating unit. A detecting arrangement, which allow the movement of the rotating body to be monitored in the form of electrical signals, are preferably provided at the rotating body and/or at the axis of rotation. This may be accomplished in multiple ways, e.g. using a push-button switch, by optically scanning the rotating body, or by mechanically sensing it with the aid of a toothed wheel.

A particularly preferred refinement of the present invention allows the rotating body to tilt to both sides, about an axis that is transverse to, and preferably perpendicular to, its axis of rotation. This allows the following functionality with respect to a cursor: By rotating the rotating body, e.g. a cursor may be moved up or down in a menu of a display, as a function of the direction of rotation. This cursor may be moved to the left and to the right by laterally tilting the rotating body to one side or the other side.

The tilting function may be provided by various specific embodiments. For example, the axis of rotation of the rotating body may be pivoted. In this case, it is preferable for, e.g. contacts to be provided in the region of the axis, which detect this tilting motion for electrical evaluation. However, it is equally advantageous for the rotating body to be supported at the axis of rotation so as to be able to tilt. In such a specific embodiment, it is advantageous for an appropriate detection arrangement contact elements to be formed on the lateral surfaces of a rotating body, which is, e.g. cylindrical or disk-shaped.

In a further preferred embodiment of the present invention, the axis of rotation of the rotating body is positioned in a direction essentially parallel to a lateral edge of an operator interface. This measure allows the rotating body to be positioned approximately perpendicularly to the operator interface, so that the rotating body may be moved parallelly to the operator interface, and, by this means, the rotating body is rotated. In this context, it is also advantageous when the rotating body only partially projects from the operator interface. In this manner, the rotating body may easily be rotated or tilted by the fingers, when a hand is laid on the operator interface.

In order to allow operation that requires as little eye contact as possible, it is further suggested that the rotating body and/or the support of the rotating body be such, that an increased haptic feedback may be experienced by the user in the event of rotation. This can be accomplished in the form of nubs or a comparable surface pattern on the outer surface of the rotating body, or by a bearing in which the rotating body has a resistance to rotation that periodically fluctuates in small angular segments during rotation. In addition, the material of the rotating body may be a plastic material, which is capable of being gripped and has a soft surface that allows the hand of a user to adhere to it well.

In order to allow a simple acknowledgment of a desired input, in particular on a user interface, it is also proposed that, with respect to the rotating body, a switching element be situated in the gripping range of a hand. In particular, it is advantageous to position, in each case, operating elements on the operator interface, at both ends of the rotating body preferably designed as a disk-shaped disk, on both ends of the rotating body whose narrow side protrudes from the operator interface, since the configuration of the rotating body already provides a perceptible indication in the direction of these control elements, so that operation without eye contact is made easier.

In addition, it is advantageous to position the rotating body in a region raised above the rest of the control panel, so that the rotating body may easily be felt. In this context, it is particularly advantageous to position the additional operating elements above and below the rotating body, at an edge of the raised region, so that these may also be felt easily.

The operating unit described just now is preferably used in the control panel of a vehicle, in particular for operating a user interface of a vehicle navigation system displayed on a video screen.

### BRIEF DESCRIPTION OF THE DRAWINGS

FIG. 1 shows a block diagram of an operating unit.

FIG. 2 shows a schematic side view of a tilting wheel of an operating unit, with respect to an operator interface.

FIG. 3 shows an operating device of the present invention, having an operating element of the present invention for operating a user interface represented in a display.

### DETAILED DESCRIPTION

The present invention may be used for controlling any electrical devices. The use of the present invention is particularly advantageous in devices, in which only a small amount of space is available for setting up a control. In particular, the use of an operating unit of the present invention is advantageous for controlling a driver-information device in a vehicle, where several vehicle functions should be controlled via a display, and using as few operating elements as possible, without distracting a driver too much from the control of his vehicle.

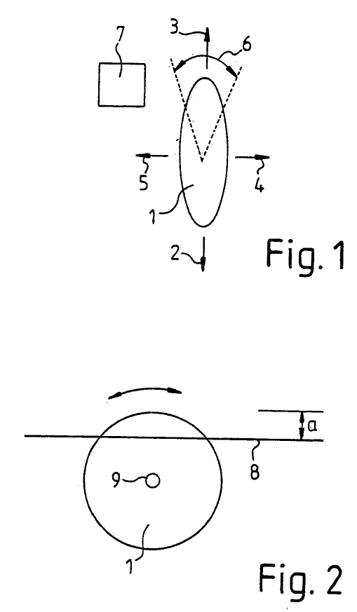

FIG. 1 shows a tilting wheel 1 and its possibilities for movement, illustrated by arrows 2, 3 and 4, 5, as well as double arrow 6. A push-button switch 7 is provided next to tilting wheel 1, within reach of a hand.

Using the tilting wheel, a user may control the movement of, e.g. a cursor on the user interface of a video screen, in menu entries or in a letter field (speller), by rotating the tilting wheel up (arrow 3) or down (arrow 2) in the vertical direction. Tilting wheel 1 may freely rotate about an axis of rotation 9, which is situated below an operator interface 8 (see FIG. 2) that is preferably designed as a control cover of the device to be operated.

In each incremental change of direction towards the top or bottom in accordance with arrows 2, 3, the user preferably experiences haptic feedback. The feedback may also occur optically and/or haptically, using protuberances or depressions formed on the wheel in the form of, e.g. cross grooves, hemispheres, points, or the like. Tilting wheel 1 may be rotated at different speeds and is therefore suitable for selection of field elements arranged one after the other, or also for rapid scrolling, by rotating tilting wheel 1 correspondingly quickly.

Changes in the direction of a cursor to the left or right with respect to, e.g. a main vertical direction may be accomplished by horizontally tilting the wheel to the left in accordance with arrow 5, or to the right in accordance with arrow 4, using a finger, e.g. the thumb. The mobility radius for tilting to the left or right is illustrated by double arrow 6. Upon tilting the wheel about an axis, preferably in a direction perpendicular to the tilt axis, the user experiences, for example, haptic feedback in the form of a switching resistance and/or a switching noise.

Tilting wheel 1 preferably stands above operator interface 8 at a distance a. This measure allows the tilting wheel to be operated in a particularly simple manner, in that the user lays his hand on the operator interface and appropriately moves the tilting wheel, using the fingers.

The combination of push-button switch 7 with tilting wheel 1 additionally allows the above-mentioned functionality with respect to the movement of a cursor to be increased by the function of an entry key (OK button, ENTER key, etc.). In a user interface, push-button switch 7 allows, for example, an input operation to be activated or a character focused on by the cursor to be selected from a letter field (speller), among individual characters, in particular letters, that are arranged side by side.

The combination of tilting wheel 1 and push-button switch 7 allows, for example, the following functionality to be achieved for operating a speller on a video screen:

| Push-button | | Tilting of the | |
|---|---|---|---|
| Switch | Tilting Wheel | Tilting Wheel | Action |
| not pressed | no rotation | no tilting | none |
| not pressed | no rotation | tilt to the left | movement to the left |
| | | | in a letter field |
| not pressed | no rotation | tilt to the right | movement to the |
| | | | right in a letter field |
| not pressed | rotate up | no tilting | upward movement |
| | | | in a letter field |
| not pressed | rotate down | no tilting | downward |
| | | | movement in a letter |
| | | | field |
| pressed | movement of the | movement of the | retrieval of the |
| | tilting wheel is | tilting wheel is | character selected in |
| | not considered | not considered | the letter field |
| | | | (termination of |
| | | | input) |

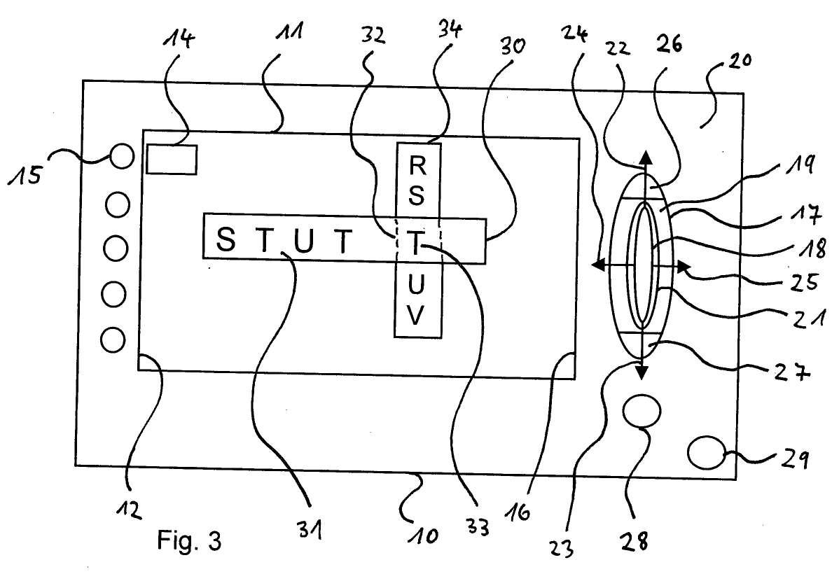

An operating device 10 of a driver-information device in a vehicle is represented in FIG. 3. Operating device 10 forms a front panel of the driver-information device, which is preferably mounted in a standardized installation slot in a center console or an instrument panel of a motor vehicle. A display area 11, which is used to display the user interface for controlling the driver information device, is situated on operating device 10. A menu structure, which is used for selecting individual functions of the driver-information device, is preferably situated in the user interface. The driver-information device includes, in particular, a vehicle navigation system for guiding a vehicle from a starting position to an input destination, via a road network. In addition, the driver-information device is used as an on-board computer for controlling vehicle functions, e.g. air conditioning, and for representing vehicle states, e.g. vehicle malfunctions. Furthermore, the driver-information device is used as a communications interface, e.g. as an automobile radio device, a mobile radio interface, or an interface to a data network, e.g. the Internet. The user interface represented in display area 11 is controlled by operating units situated on the operating device, i.e. on the front panel of the driver-information device. Push-buttons 15, to whom operating fields 14 of display area 11 may be variably assigned, are situated at a first, short, lateral edge 12 of display area 11. An operating unit 17 of the present invention, which has a rotating body 18, is situated at a second, short, lateral edge 16 of display area 11. Operating unit 17 has a region 19 raised above the rest of the operator interface 20 of the operating device, so that operating unit 17 may easily be felt without eye contact. A trough-shaped depression 21, in which the rotating body projects above operator interface 20 at elevation a, is introduced into raised region 19. The axis of rotation and the tilt axis of rotating body 18 run below operator interface 20, so that only a small part of rotating body 18 projects above operator interface 20. Rotating body 18 may rotate in a first direction 22 parallel to second, short, lateral edge 16 of display area 11. In addition, rotating body 18 may also rotate in a second direction 23, which is opposite to first direction 22. Furthermore, rotating body 18 may be tilted in a first tilting direction 24 perpendicular to first and second directions 22, 23, in the direction of display area 11. In addition, rotating body 18 may rotate in a second tilting direction 25, which is opposite to first tilting direction 24. In this context, the tilting of rotating body 18 is limited by trough-shaped depression 21, in that the trough-shaped depression preferably forms a limit stop for rotating body 18.

Starting out from rotating body 18, a first push-button 26 is situated in first direction 22, and a second push-button 27 is situated in second direction 23, on an edge of raised region 19. In this context, first push-button 26 is used for selecting a menu in display area 11, so that a primary menu mode may be called up in display area 11 by pressing first push-button 26, without this primary menu mode having to be selected by the operator with the aid of rotating body 18. Since first push-button 26 is also situated on raised region 19, it may also be easily felt by a user, in the same way as rotating body 18, even without eye contact. Second push-button 27 is preferably used as a confirmation key of a selection made in display area 11, using rotating body 18. A further control element 28 in the form of a push-button is positioned on operator interface 20, spatially separated from operating unit 17, but in its vicinity, preferably beneath rotating body 18. Further operating element 28 is used as an undo key, by which an input may be canceled. If an operating error is actually made by a user, then further operating element 28 may easily be grasped, in order to undo the erroneous input. An on/off switch 29, which is also preferably in the form of a push-button, is positioned so as to be spatially separated from operating unit 17, so that the driver-information device is prevented from being inadvertently switched off.

In display area 11, the input of a destination into the driver-information device is represented as an example of a selection made with the aid of the operating unit 17 of the present invention. The destination is input as letters in a first region 30, which is displayed horizontally in display area 11. Letters 31 input up to this point are situated to the left of an input marker 32, which is delimited by a dotted line. A currently selected letter 33 is displayed inside input marker 32. A second region 34, which is positioned in a direction parallel to rotating body 18 and thus perpendicular to first region 30, is situated in the region of input marker 32. Displayed in second region 34 are letters, which may be selected by input marker 32, but have presently not been chosen. The letter displayed in input marker 32 may be replaced by the letters displayed in the rest of the second region, by turning rotating body 18 in first direction 22 or second direction 23. The change corresponds to the direction in which rotating body 18 is manipulated. To input the next letter, one may shift to the right by manipulating rotating body 18 in the second tilting direction. By tilting rotating body 18 in first tilting direction 24, a shift is made to the left, to the input of a previous letter, in order to change it. In a preferred exemplary embodiment, only letters, whose input leads to the completion of a word stored in a database of the driver-information device or a database of a vehicle navigation system, are displayed in second region 34. After the sequence of letters, “Stut”, selected in the exemplary embodiment is input, examples of this could include the letter “t” for the subsequent input of “Stuttgart”, or an “e” for the subsequent input of “Stutensee”. By this means, the selection of a user is limited to the letters that are suitable for input, so that, in order to make a change, one is prevented from having to manipulate the rotating body past letters that may not be selected.

In addition to the operating elements represented here, other operating elements may be positioned on the operator interface, in particular at the two long, lateral edges of display area 11.

What is claimed is:

1. An operating unit for operating a user interface of an electrical device, having a rotating body (1, 18) that may rotate about an axis of rotation (9), the axis of rotation (9) of the rotating body (1, 18) being positioned in a direction essentially parallel to the operator interface (8, 20), the rotating body (1, 18) being able to tilt about an axis perpendicular to the axis of rotation (9), and the rotating body being positioned on an operator interface in such manner, that a narrow side of it protrudes from the operator interface,
wherein an operating element (7, 26, 27, 28) is situated adjacent to the rotating body (1, 18), the operating element (7, 26, 27, 28) is a switching element, preferably a push-button, and the operating element (26, 27) is situated on the operator interface (20), next to the rotating body (18).

2. The operating unit as recited in claim 1,
wherein the movement of a cursor on a display area (11), in particular in a letter field, may be controlled by operating [manipulating] the rotating body (1, 18).

3. The operating unit as recited in claim 2, wherein a menu mode [menu control] displayed in the display area (11) may be called up, using the operating element (26).

4. The operating unit as recited in one of the preceding claims,
wherein a desired input may be acknowledged, using the operating element (7, 26, 27).

5. The operating unit as recited in one of the preceding claims,
wherein an operating element (26, 27) is situated at each of the two ends of the rotating body (18) protruding from the operator interface.

6. The operating unit as recited in one of the preceding claims,
wherein, in the vicinity (19) of the rotating body (1, 18), the operator interface (8, 20) is raised above the rest of the operator interface (8, 20).

7. The operating unit as recited in one of the preceding claims,
wherein an operating element (28) for undoing an input is situated next to the rotating body (18).

8. The operating unit as recited in one of the preceding claims,
wherein the rotating body (1, 18) may tilt to both sides, about an axis perpendicular to its axis of rotation (9).

9. The operating unit as recited in one of the preceding claims,
wherein the axis of rotation (9) may be tilted.

10. The operating unit as recited in one of the preceding claims,
wherein the rotating body (1, 18) is supported at the axis of rotation (9) so as to be able to tilt.

11. The operating unit as recited in one of the preceding claims,
wherein only a part of the rotating body (1, 18) protrudes from an operator interface (8, 20).

12. The operating unit as recited in one of the preceding claims,
wherein the rotating body (1, 18) and/or the bearing [support] of the rotating body are such that, in the event of rotation, an increased haptic feedback is perceptible to the user.

13. The operating unit as recited in one of the preceding claims,
wherein, in relation to the rotating body (1, 18), the operating element (7, 16, 27) is situated within the reach of a hand.

14. An operating device in a vehicle, in particular for operating a driver-information device, comprising a display area (11) for displaying a user interface (14, 30, 34), and an operating unit as recited in one of the preceding claims,
wherein the operating unit (17) is situated next to the display area (11).
